(19) United States
(12) Patent Application Publication
(10) Pub. No.: US 2009/0192782 A1
(43) Pub. Date: Jul. 30, 2009

(54) Method for increasing the accuracy of statistical machine translation (SMT)

(76) Inventor: William Drewes, Houston, TX (US)

Correspondence Address: WILLIAM DREWES, SUITE 1968, 14781 MEMORIAL DRIVE, HOUSTON, TX, 77079, US

(21) Appl. No.: 12/321,436

(22) Filed: Jan. 21, 2009

Related U.S. Application Data
(63) Continuation-in-part of application No. 12/290,761, filed on Nov. 3, 2008.
(60) Provisional application No. 61/024,108, filed on Jan. 28, 2008.

(51) Int. Cl. G06F 17/28; H04M 3/42

(52) U.S. Cl. 704/3; 704/2; 379/202.01

(57) ABSTRACT

A method to significantly improve the accuracy of Statistical Machine Translation (SMT) translation output, while increasing the effectively of the required ongoing human translation effort by correlating said ongoing professional human translation effort directly to the translation errors made by the system. Once said translation errors have been corrected by professional human translators and re-input to the system, the SMT's inherent “learning process” will ensure that the same, and possibly similar, translation error(s) will not occur again.

### CROSS-REFERENCE TO RELATED APPLICATIONS

This application claims priority from provisional application Ser. No. 61/024,108, filed on Jan. 28, 2008. This application is a Continuation-in-part (CIP) of application Ser. No. 12/290,761, filed on Nov. 3, 2008.

### BACKGROUND OF THE INVENTION

1. Field of the Invention

Statistical machine translation (SMT) is a machine translation paradigm where translations are generated on the basis of statistical models whose parameters are derived from the analysis of bilingual text corpora. The statistical approach contrasts with the rule-based approaches to machine translation as well as with example-based machine translation.

2. Description of Prior Art

The first ideas of statistical machine translation were introduced by Warren Weaver in 1949, including the ideas of applying Claude Shannon's information theory. Statistical machine translation was re-introduced in 1991 by researchers at IBM's Thomas J. Watson Research Center and has contributed to the significant resurgence in interest in machine translation in recent years. Another pioneer in the field of Statistical Machine Translation is Language Weaver, which is notable for recent advances in automated translation. Language Weaver is a Los Angeles, Calif.-based company that was founded in 2002 by the University of Southern California's Kevin Knight and Daniel Marcu, to commercialize a statistical approach to automatic language translation. As of 2006, SMT is by far the most widely-studied machine translation paradigm.

The benefits of statistical machine translation over traditional paradigms that are most often cited are the following:

Better Use of Resources
1. There is a great deal of natural language in machine-readable format.
2. Generally, SMT systems are not tailored to any specific pair of languages.
3. Rule-based translation systems require the manual development of linguistic rules, which can be costly, and which often do not generalize to other languages. Unlike other MT software, the time that it takes to launch a new language pair can be only weeks or months instead of years.

Unlike the previous generation of machine translation technology, Grammatical translation, that relied on collections of linguistic rules to perform an analysis of the source sentence, and then map the syntactic and semantic structure of each sentence into the target language, Statistical Machine Translation uses statistical techniques from cryptography, utilizing learning algorithms that learn to translate automatically using existing human translations from one language to another (e.g., English→Chinese). Since professional human translators know both languages, the material translated to the target language accurately reflects “what is actually meant” in the Source Language, including the translation of language specific idiomatic expressions and colloquiums. As a result, the “learning process” of Statistical Machine Translation systems “learn” is up to date, appropriate and idiomatic, because it is learned directly from human translations. Unique to Statistical Machine Translation is it's capability to translate incomplete sentences, as well as utterances.

Statistical Language Pairs

A Language Pair is the main translation mechanism or translation engine of a machine translation system. Creating new language pairs and customizing existing language pairs involves a process called “training.” For statistically based translation software, training material consists of previously translated data. The translation system learns statistical relationships between two languages based on the samples that are fed into the system. Because it looks for patterns, the more samples the system sees, the stronger the statistical relationships become.

Once translated data is collected, parallel documents (the original and its translation) are identified and aligned sentence by sentence to create a “Parallel Corpus”. The SMT system processes this corpus and extracts statistical probabilities, patterns, and rules, which are called the “Translation Parameters” and “Language Model.” The Translation Parameters are used to find the most accurate translation, while the Language Model is used to find the most fluent translation. Both of these components are used to create a new language pair and become part of the delivered translation software for each language pair.

In general, the Statistical Translation process is at the sentence level (sentence by sentence) and has three basic steps. First, the source sentence is scanned for known language specific idioms, expressions and colloquialisms, which are then translated into object language words which express the true intended meaning of the language specific idiom, expression, or colloquialisms. Secondly, the words of the sentence that can have more than one possible meaning, are given statistical weights or probabilities as to which of the possible meanings of the word, is actually the intended meaning of the word within the particular sentence. Lastly, once the actual meaning of the sentence has been determined, the Language Model component will use this raw data to build a fluent and natural sounding sentence in the target language.

Subject Specific Domains

A Domain is essentially the same as a Statistical Language Pair, described above, with the single exception that all source language material to be translated, as per above, is “subject specific” meaning that all recorded material to be translated from the source to the target language, relates precisely to people talking about the same subject. When everybody is talking about the same subject, the meaning of words can then be construed “in the context of the subject”, and the accuracy of the translation is significantly increased. As a result, the probabilities of choosing the correct meaning of a word or expression, among the various possible meanings of said word or expression are significantly more apparent and explicit, and therefore higher, when used in the context of a specific subject.

The subject scope of domains can be either small or large, and still retain the accuracy benefits of using a subject specific domain. An example of large scope Subject Specific Domain is IBM's MASTOR PC based Voice to Voice translation system with a Subject Specific Domain relating to “The war in Iraq”. This system is currently being used by U.S. forces in Iraq to interactively communicate with Arabic speaking Iraqis, and is reported to achieve high accuracy interactive translation results.

Inaccuracies Inherent in SMT

In order for international business to use and rely on SMT translations on a large scale, the crucial imperative is that SMT translations must be consistently accurate. Translation mistakes are simply not acceptable when money is dependent on the translation accuracy of what you say or write and what is said or written to you across different human languages.

In a theoretically perfect SMT world, SMT Language Pairs and Subject Specific Domains would be “complete” containing all possible sentence constructs, all possible usages of words, language specific idioms, phrases, expressions and colloquialisms, and as a result, should achieve near perfect translation results, but in reality this is not the case.

One basic problem is the availability and cost of professional human translations. Typically, professional human translation of at least 25 million words is required to build a single robust Statistical Language Pair. In addition, Subject Specific Domains of a medium to large scope typically require professional human at least 10 million words, all relating directly to the specific subject of the Domain.

Among major western countries, such as the U.S.A., France and Germany enough bilingual human translation achieves exist for the initial creation of Statistical Language Pairs. In order to ensure that said Statistical Language Pairs stay up-to-date with, and relevant to the natural changes to languages that evolve over time, ongoing human translation of a statistically valid portion of all original language material submitted for translation by users of the system, must also be translated by professional human translators, and re-input to the system in order to “refresh” and keep said Language Pair up-to-date.

The problem with the above detailed process of updating and refreshing Statistical Language Pairs is that there is no direct correlation between the translation errors made by the SMT system, and the “statistically valid” ongoing professional human translations of original language material submitted for translation by users of the system.

As a result, translation errors continue to be made by the system due to deficiencies in a Statistical Language Pair's lack of knowledge relating to certain sentence constructs as well as the particular usages of certain words, language specific idioms, phrases, expressions and colloquialisms. The exact same problem also pertains to Subject Specific Domains, described above.

It would therefore be most beneficial for a method to be devised which will both ensure a significantly improved accuracy rate of SMT translations, while at the same time increasing the effectively of the required ongoing human translation effort and related cost thereof by specifically correlating the professional human translation effort directly to the translation errors made by the system. Once said translation errors have been corrected by professional human translators and re-input to the system, the SMT's inherent “learning process” will ensure that the same, and possibly similar, translation error(s) will thereafter not occur again.

### 3-SUMMARY OF THE INVENTION

The inherent “statistical” nature of Statistical Machine Translation (SMT) and the way that it works lends itself to a simple solution that will significantly improve the accuracy of Statistical Machine Translation (SMT) translation, while at the same time increase the effectively of the required ongoing human translation effort and related cost thereof by specifically correlating the professional human translation effort directly to the translation errors made by the system.

First, the basic unit of translation of SMT is “the sentence”, in that SMT translates a document one sentence at a time, sentence by sentence.

Secondly, since the essence of SMT is statistical in that it determines probabilities for the different possible meanings of words and phrases within a sentence, it also has the innate capability to calculate the probability that each word and/or phrase within each has sentence has been translated correctly.

For example, if the different probabilities relating to four possible different possible meanings of a particular words or phrase within a sentence are: 73%, 21%, 5% and 1% respectively, there is a high probability that the meaning of the word or phrase relating to the 73% probability of correctness, is, in effect, the correct meaning of the particular word or phrase.

On the other hand, if the different probabilities relating to the same four possible different possible meanings of a particular words or phrase within a sentence are: 26%, 25%, 25% and 24% respectively, there is a high probability that the correct meaning of the word or phrase cannot be determined by the SMT system. In this case, there is a one in four probability that “any” of the four possible meanings of the word or phrase, may be the correct meaning. As a result, the SMT system inherently “knows” that the definite probability is that the resulting translation of this particular sentence is statistically inconclusive. While in the above example, we are talking about the possible different meanings of a single word or phrase within a sentence, each sentence may have multiple words or phrases with different possible meanings. Therefore any lack of definitive probability results for any of these multiple words or phrases with different meanings within the sentence, can then signal to the SMT system that the resulting translation of this particular sentence is most probably incorrect.

Currently, no statistical verification is performed by SMT systems to determine if a sentence has been translated correctly or not. Said SMT systems currently choose the meaning of a specific phrase or word within a sentence with the highest probability score, regardless if said selected meaning of said phrase or word is “statistically conclusive” or not.

Modifications and additions to the SMT system enabling said detection of the probability that a sentence has been translated correctly, as detailed herein below, can be readily programmed by those skilled in the art based upon said disclosures.

According to the present method, a sentence is determined to have been translated correctly, only in the event that every phrase and/or word within said sentence with more than one possible meaning, must have respective “probability spreads” for said phrases and/or words within said sentence indicating that all of the chosen meanings for all phrases and/or words within said sentence, that have more than one possible meaning, are “statistically conclusive” choices, in which case said sentence is determined to have been “translated correctly”, otherwise said sentence is determined to have been “translated incorrectly”.

Two separate Translation Error Correction systems to effect the correction of incorrectly translated “Bulk Text Material” sentences as well as incorrectly translated “Interactive Conversational Data” sentences are presented and explained.

Professional human translation will then utilize said Translation Error Correction system to correctly translate the source language sentence into a corresponding target language sentence, thereby creating correctly translated “Parallel Corpus” source and target language sentences. Said correctly translated “Parallel Corpus” source and target language sentences will then be re-input to the respective “Statistical Language Pair” and/or “Subject Specific Domain”, thus utilizing the “learning capability” of the SMT system to expand the knowledge base of said SMT system, thereby ensuring that said incorrectly translated sentence will be thereafter translated correctly.

### BRIEF DESCRIPTION OF THE DRAWINGS

FIG. 1 is a diagram illustrating the flow of the Bulk Text Material Sentence Translation Error Correction Process.

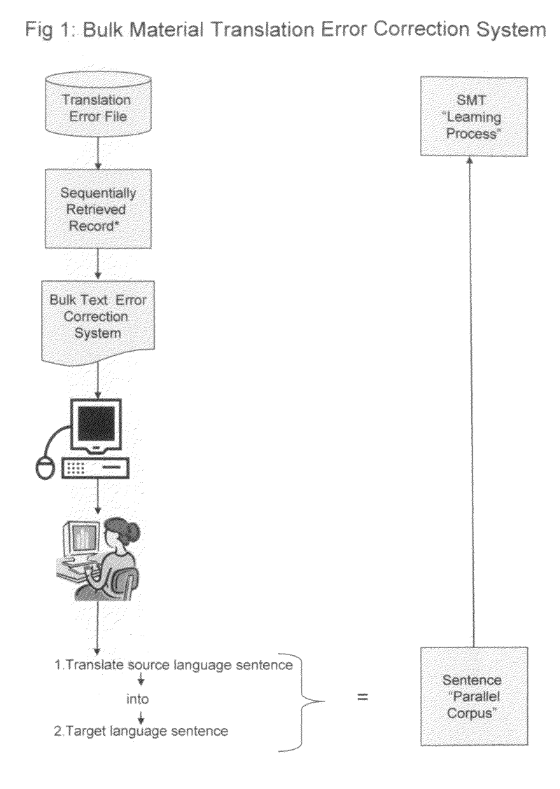

FIG. 2 is a diagram illustrating the flow of the Interactive Conversational Sentence Translation Error Correction Process.

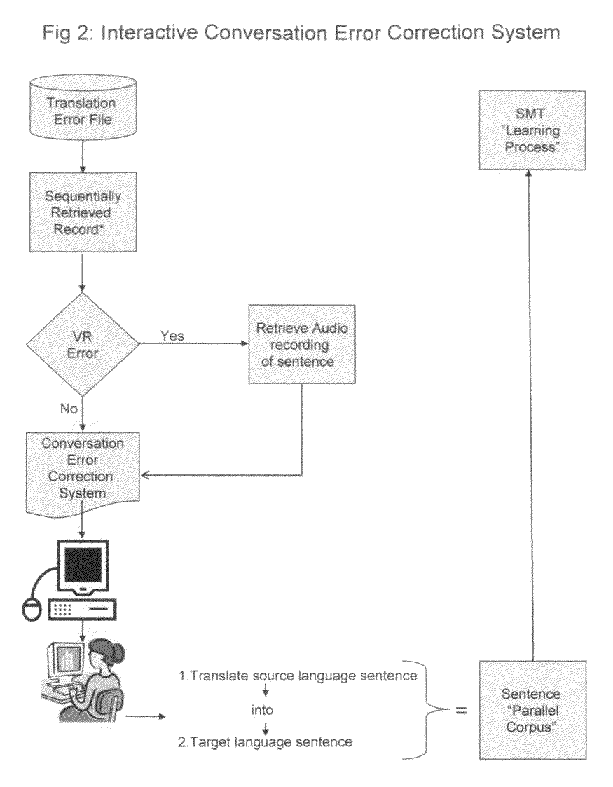

### 4-DETAILED DESCRIPTION OF THE INVENTION

There are two basic types of material that both can be submitted for translation by SMT, that are addressed within the scope of the present invention, as follows: (1)-Bulk material consisting of prewritten material consisting of multiple sentences, often many pages consisting of multiple sentences, and (2)-Interactive Conversational Data, such as the telephony voice-to-voice translation of conversation participant dialogue in real-time among two or more participants, as disclosed in U.S. patent application Ser. No. 12/290,761 entitled “Voice Auto-Translation of Multi-Lingual Telephone Calls.

Since, within the scope of the present invention, there are two basic types of material that can be submitted for translation, the user and system processes required when the SMT system has determined that the probability of a sentence has been translated incorrectly, differs with each said type of material, and is detailed herein below.

4.1—Regarding Bulk material consisting of prewritten material containing multiple sentences, often many pages consisting of multiple sentences, SMT is currently often used to produce a first rough translation draft that is then corrected manually, with no relation to or interaction with the SMT system.

In order to reap the benefits of the present invention, specific modifications and additions to the abovementioned Auto-Translation Telephony System are herein defined as follows:

Background Information:

4.2-Regarding “Interactive Conversational Data”, as taught in U.S. patent application, Ser. No. 12/290,761 entitled “Voice Auto-Translation of Multi-Lingual Telephone Calls”: (1)-The individual components of the Voice-to-Voice translation process consists of “. . . the steps of Voice Recognition to Text of current conversation participant speaker dialogue, followed by Text-to-Text Machine Translation from said current conversation speaker's language of choice to each of said other conversation participant(s) said language(s) of choice, followed by Voice Synthesis of said translation(s) text in each of said other conversation participant(s) respective language(s) of choice . . . ”, and (2)-Functionality requests on the part of conversation participants are conveyed to the system through “. . . The use of Telephone Keypad Digital Signal Processing (DSP) or Voice Commands to enable said conversation participants to convey specific pre-defined functionality requests and other pre-defined information to said Command and Control module component . . . ”.

Required Modifications:

4.3-A “Translation Error File” will be created containing a unique file identification Key which identifies (directly relates to) each specific Auto-Translation Telephony System conversation processed by the system, as detailed below.

4.4-Said “Translation Error File” will contain a unique file identification key that uniquely identifies the specific “Bulk Text Material” document, submitted for SMT translation, and a unique key for the retrieval of the corresponding “Sentence Information File” record, as detailed below.

4.5-A “Sentence Information File” (SIF) will be created containing a unique file identification Key which identifies (directly relates to) each specific Auto-Translation Telephony System conversation processed by the system, as detailed below.

4.6-An audio recording of each sentence spoken by each conversation participant speaker's dialogue is made in real-time, and stored in said “Sentence Information File” record (SIF record) which will be created and stored in said “Sentence Information File” (SIF File). Each SIF file record relates to each single sentence spoken by a spoken by a specific single participant throughout a specific Auto-Translation Telephony System conversation. Said SIF record will contain information identifying the specific conversation participant who spoke the sentence, as well as a unique indicator identifying said specific conversation.

In the event that a Voice Recognition (VR) error occurs in the VR Voice to Text transcription of a specific sentence, said VR error occurrence, as well as the text created by the VR component for the specific sentence, said sentence, as spoken by the conversation speaker, is recorded and stored in the SIF record corresponding to said sentence.

4.7-Since SMT translates text on a “sentence-by-sentence” basis, it is important to know where a sentence ends. Whereas, in most languages, written text has a period at the end of a sentence, which, of course, is not the case with spoken dialogue. Voice Recognition (VR) components have methodologies, known to those skilled in the art, to determine with a high probability of accuracy the location of the end of a sentence.

Preferably, indicating the location of the end of each sentence will be made incumbent on each conversation participant in said “Auto-Translation Telephony System”. This can be accomplished by the use of DSP (Digital Signal Processing), wherein said conversation participant will be required to press a specific telephone keypad button (e.g., “*” button) to indicate that he or she has completed vocalizing a single complete sentence.

4.8-Said complete sentence is then conveyed to the SMT module that will determine the probability of whether said sentence has been either translated correctly or translated incorrectly. Communications to and from the SMT module may be facilitated through a standard programming technique known as an “API” (Application Program Interface) module which is programmed for such passing of information between program modules, and is known to those skilled in the art, as detailed below.

4.9-In the case that the SMT module determines that there is a high probability that said sentence has been translated correctly, as detailed below, the conversation participant who spoke the sentence will hear a DSP signal, such as “beep-beep”, generated by the Auto-Translation Telephony System Command & Control module, indicating to said conversation participant that said previous sentence spoken by said participant was translated correctly, and that said conversation participant may continue to vocalize his or her next sentence.

4.10-In the case that the SMT module determines that there is a high probability that said sentence has been translated incorrectly, as detailed below, and/or a Voice Recognition (VR) error has been detected in a said sentence by the VR component, the Auto-Translation Telephony System Command & Control module will: (1)-Utilize Voice Synthesis to Inform said conversation participant who spoke the sentence, in said participants respective “language of choice” that said sentence “Was not understood by the system”, and (2)-The SIF file record corresponding to said sentence is retrieved, and said audio recording stored therein of said conversation participant speaking said sentence is played to said conversation participant, and (3)-Utilizing Voice Synthesis, said conversation participant is requested, in said conversation participant's language of choice, to rephrase and vocalize the sentence in a “Simplified and Clarified” manner. (4)-A “Translation Error File” record is generated containing the unique identification and location of SIF file record corresponding to said sentence, and said “Sentence Error Record” is stored in a “Sentence Error File” which will be subsequently processed by the “Sentence Error Correction System” described herein below. Said Translation Error File for Interactive Conversation Data” record will contain both a source language sentence that was submitted for translation, as well as the corresponding translated target language sentence, as detailed below. It should be noted that in the case of a Voice Recognition error in said sentence in which one or more words were not recognized by the Voice recognition component, the sentence text generated by said VR error, said Voice Recognition component will most probably transcribe text for said sentence that will be determined to have a high probability of having been “translated incorrectly” by the SMT system. (5)-The above process is repeated until the SMT module determines that there is a high probability that said rephrased sentence has been translated correctly. In this manner, the above process assures that when a sentence is determined to have been translated correctly, even though it may not be the speakers original sentence, what is finally translated and heard by the other conversation participants, in each conversation participants' own respective language of choice, actually conveys the true “meaning and intent” of the speaker.

In order to reap the benefits of the present invention, specific modifications and additions to the abovementioned Statistical Machine Translation (SMT) system are herein defined as follows:

4.11-A Method that utilizes the inherent statistical nature of SMT in the translation of a source language sentence to a target language sentence, the individual “sentence” being the basic unit of SMT translation, to determine if said sentence has been translated correctly to the target language or not, comprising:
When said sentence contains phrase(s), and/or individual word(s) that have more than one possible meaning, said SMT translation process determines the statistical probability of each possible meaning of each said phrase or word utilizing statistical analytics derived from either or both the SMT language pair database and/or a particular domain database to determine the statistical “probability spread” of each possible meaning of each said phrase or individual word in said sentence being translated.
When said statistical “probability spread” relating to the possible different meanings of a particular phrase or word, in said sentence, that has more than one possible meaning is “statistically conclusive”, in that there is a high statistically valid probability in said statistical “probability spread”, relative to the “probability scores” of the other possible meanings of said phrase or word, points to one of said possible meanings of said word or phrase points as the “statistically conclusive”, said “statistically conclusive” meaning of said word or phrase is then chosen as the “correct meaning” of said word or phrase to be used in said translation of said sentence.
When said statistical “probability spread” relating to the possible different possible meanings of a particular phrase or word within said sentence is “statistically inconclusive”, in that there is not a high statistically valid probability in said statistical “probability spread”, relative to the “probability scores” of the other possible meanings of said phrase or word, that points to any one of the possible meanings of said word or phrase as the statistically correct meaning, said SMT system does not know and cannot determine which of the multiple possible meanings of said word or phrase is the “correct meaning” of said phrase or word.
For example, in the case that the statistical “probability spread” of a phrase or word, within said sentence, that has four different possible meanings which are: 73%, 21%, 5% and 1% respectively, there is a high “statistically conclusive” probability that the meaning of the word or phrase correlating to the 73% probability of correctness, is indeed the correct meaning of said phrase or word. Alternately, in the case that the above said “probability spread” is 27%, 26% 25% and 22% respectively, there is no “statistically conclusive” probability that any of the meanings of said phrase or word correlating to the above “probability spread” is the “statistically correct” meaning, and the SMT system is unable to conclusively translate the above said phrase or word.
According to the present method, a sentence is determined to have been translated correctly, only in the event that every phrase and/or word within said sentence with more than one meaning, have respective “probability spreads” for said phrases and/or words within said sentence indicating that all of the chosen meanings for all phrases and/or words within said sentence, that have more than one possible meaning, are “statistically conclusive” choices, in which case said sentence is determined to have been “translated correctly”, otherwise said sentence is determined to have been “translated incorrectly”.

4.12-Said SMT system will be modified to determine if a translated sentence has either been “translated correctly” or “translated incorrectly”, as detailed in claim 1, and said SMT system will utilize an API (Application Program Interface) to extract and provide any external module with the below detailed information and/or any other method of extracting below detailed information from said SMT system for use by any external module, known to those skilled in the art:
1-Text of original Source Language Sentence
2-Text of translated Target Language Sentence
3-For sentences that contain phrase(s) and/or words with multiple meaning(s), a list of said phrase(s) and/or word(s) that the SMT system has determined to be “Statistically Inconclusive”.
4-An indicator whether said Source Language Sentence has either been “translated incorrectly” or “translated correctly”.
5-A unique file record identification key to be used for the creation and subsequent retrieval of an associated “Sentence Information File Record”. Note: Used only for “Auto-Translate VR Data, else=null.
6-Document (or) Auto-Translate Conversation Id
7-Source System Indicator—Bulk Text Material (or) Auto-Translate VR

4.13-A computer program will be developed that will access and process said information extracted from said modified SMT system file, said program comprising
The creation of a “Translation Error File” file containing a unique file identification key, that uniquely identifies the specific “Bulk Text Material” document, submitted for SMT translation.
The generation of a “Translation Error File” record for each sentence translated sentence within said Bulk Text Material document. Said “Translation Error File” record will contain the below detailed data extracted from said SMT system subsequent to the translation by said modified SMT system of said sentence in said “Bulk Text Material” as follows:
   1-Text of original Source Language Sentence
   2-Text of translated Target Language Sentence
   3-For sentences that contain phrase(s) and/or words with multiple meaning(s), a list of said phrase(s) and/or word(s) that the SMT system has determined to be “Statistically Inconclusive”.
   4-An indicator whether said Source Language Sentence has either been “translated incorrectly” or “translated correctly”.
   5-A unique file record identification key to be used for the creation and subsequent retrieval of an associated “Sentence Information File Record”. Note: Used only for “Auto-Translate VR Data, else=null.
   6-Document (or) Auto-Translate Conversation Id
   7-Source System Indicator—Bulk Text Material (or) Auto-Translate VR

4.14-A computer program will be developed that utilizes said “Translation Error File” to create a “Bulk Material Translation Text Report” displaying the entire source language text of said bulk material on a computer screen or hardcopy paper report, with said individual sentences that have been determined by the SMT system to have a high probability of having been translated incorrectly either highlighted, or otherwise marked in any manner whatsoever so that user attention will be drawn to said incorrectly translated individual sentences, said report being generated for viewing on either hardcopy paper or computer screen, or by any other means known to those skilled in the art. Furthermore, said highlighting of said sentences that have been “translated incorrectly” will be highlighted in one color (e.g., yellow), while the specific phrase(s) and/or word(s) within said sentence that have multiple possible meanings which said SMT system has determined to be “Statistically Inconclusive” (i.e., was unable to choose the correct meaning for said phrase and/or word) will be highlighted in a different color (e.g., red). In this manner, said professional human translator(s) will know specifically which phrases and/or words said SMT system did not understand, and will be able to more effectively translate a “parallel Corpus” for said sentence which more effectively addresses and corrects the specific problems in said sentence in such a way that said SMT system can more effectively learn specifically “what it does not know”.

In order to reap the benefits of the present invention, a “Bulk Material Translation Error Correction” system will be developed, as detailed below:

4.15-A “Bulk Material Translation Error Correction” system will be developed, said “Bulk Material Translation Error Correction” system comprising:
The selection of each said individual record in said “Translation Error File”” that contains a sentence that has been “translated incorrectly” by said modified SMT system will be presented to a professional human translator, one record (sentence) at a time by said Bulk Material Translation Error Correction” system.
The highlighting of said sentence that have been “translated incorrectly” and presented to a professional human translator, one record (sentence) at a time will be highlighted in one color (e.g., yellow), while the specific phrase(s) and/or word(s) within said sentence that have multiple possible meanings which said SMT system has determined to be “Statistically Inconclusive” (i.e., was unable to choose the correct meaning for said phrase and/or word) will be highlighted in a different color (e.g., red). In this manner, said professional human translator(s) will know specifically which phrases and/or words said SMT system did not understand, and will be able to more effectively translate a “parallel Corpus” for said sentence which more effectively addresses and corrects the specific problems in said sentence in such a way that said SMT system can more effectively learn specifically “what it does not know”.
Said selected “Translation Error File” record information, relating only to records containing sentences that have been “translated incorrectly”, are presented to said professional human translator by said Bulk Material Translation Error Correction” system will include both the source language sentence that was submitted for translation, as well as the corresponding target language sentence which was determined to have a high probability of having been “incorrectly translated” by the SMT system.
Said professional human translation will then utilize said Bulk Material Translation Error Correction system record information to correctly translate said source language sentence into a correctly translated corresponding target language sentence, thereby creating correctly translated “Parallel Corpus” source and target language sentences. Said correctly translated “Parallel Corpus” source and target language sentences will then be re-input to the SMT system, so that the SMT's inherent “learning process” will ensure that the same translation error will not occur again.
When all records (i.e. sentences) in a specific “Bulk Text Material” document have been corrected as detailed above, the corrected “Bulk Material” document will then re-input for translation, and all previous translation errors should then be re-translated correctly. In the case that one or more errors still occur after said re-translation process, the above detailed use of said Bulk Material Translation Error Correction system computerized sentence correction component is repeated, and re-input for SMT translation until no further translation errors occur.

In order to reap the benefits of the present invention, an “Interactive Conversational Data Error Correction” system will be developed, as detailed below:

4.16-Said SMT system will be modified in accordance to the requirements of “Interactive Conversational Data”, such as the “Voice Auto-Translation of Multi-Lingual Telephone Calls” as disclosed in U.S. patent application Ser. No. 12/290,761, in which said SMT module determines if a translated sentence has either been “translated correctly” or “translated incorrectly”, as detailed above, and said SMT system will utilize an API (Application Program Interface) and/or any other method of extracting below detailed information known to those skilled in the art, in order to extract and provide any external module with the below detailed information:
1-Text of original Source Language Sentence
2-Text of translated Target Language Sentence
3-For sentences that contain phrase(s) and/or words with multiple meaning(s), a list of said phrase(s) and/or word(s) that the SMT system has determined to be “Statistically Inconclusive”.
4- An indicator whether said Source Language Sentence has either been “translated incorrectly” or “translated correctly”.
5-A unique file record identification key to be used for the creation and subsequent retrieval of an associated “Sentence Information File Record”. Note: Used only for “Auto-Translate VR Data, else=null.
6-Document (or) Auto-Translate Conversation Id
7-Source System Indicator—Bulk Text Material (or) Auto-Translate VR

4.17-A computer program will be developed that will access and process said information extracted from said modified SMT system, said program comprising
The creation of a “Translation Error File” containing a file identification key, that uniquely identifies the specific conversation, and the associated conversation Source Language text submitted for SMT translation.
The generation of a record in said “Translation Error File” record for each “incorrectly translated” sentence within said “Interactive Conversational Data” that has been determined to have been “translated incorrectly by said SMT system. Said “Translation Error File” will contain the below detailed data extracted from said SMT system subsequent to the translation of said sentence by said SMT system.
   1-Text of original Source Language Sentence
   2-Text of translated Target Language Sentence
   3-For sentences that contain phrase(s) and/or words with multiple meaning(s), a list of said phrase(s) and/or word(s) that the SMT system has determined to be “Statistically Inconclusive”.
   4-An indicator whether said Source Language Sentence has either been “translated incorrectly” or “translated correctly”.
   5-A unique file record identification key to be used for the creation and subsequent retrieval of an associated “Sentence Information File Record”. Note: Used only for “Auto-Translate VR Data, else=null.
   6-Document (or) Auto-Translate Conversation Id
   7-Source System Indicator—Bulk Text Material (or) Auto-Translate VR

4.18-A “Sentence Information File” for “Interactive Conversational Data” will be developed that uniquely identifies the specific “Interactive Conversational Data” conversation submitted for SMT translation. The storage and retrieval key for said record is derived from said “unique file record identification key” which is located in the above associated “Translation Error File” record. A single “Sentence Information File” record is generated for each sentence, which said SMT module has determined to be “translated incorrectly”.

Said “Sentence Information File” record will contain the below detailed data extracted from said SMT system subsequent to the translation of an “incorrectly translated” sentence, as follows:
1-Audio recording of said single sentence as spoken by conversation participant.
2-Identification of conversation participant who spoke said single sentence.
3-Unique ID for said specific telephone conversation processed by the “Voice Auto-Translation of Multi-Lingual Telephone Calls” system.
4-Indicator of if a Voice Recognition (VR) error occurred during the transcription by VR module of said sentence from Voice to Text.

4.19-The “Interactive Conversational Data Error Correction” system will be developed, said “Interactive Conversational Data Error Correction” system comprising:
The selection of each said individual record in said “Translation Error File” that contains a sentence that has been “translated incorrectly” by said modified SMT system will be presented to a professional human translator, one record (sentence) at a time by said “Interactive Conversational Data Error Correction” system.
Said selected “Translation Error File” record information, relating only to records containing sentences that have been “translated incorrectly”, are presented to said professional human translator by said “Interactive Conversational Data Error Correction” system will include both the source language sentence that was submitted for translation, as well as the corresponding target language sentence which was determined to have a high probability of having been “incorrectly translated” by the SMT system.
The highlighting of said sentence that have been “translated incorrectly” and presented to said professional human translator, one record (sentence) at a time will be highlighted in one color (e.g., yellow), while the specific phrase(s) and/or word(s) within said sentence that have multiple possible meanings which said SMT system has determined to be “Statistically Inconclusive” (i.e., was unable to choose the correct meaning for said phrase and/or word) will be highlighted in a different color (e.g., red). In this manner, said professional human translator(s) will know specifically which phrases and/or words said SMT system did not understand, and will be able to more effectively translate a “parallel Corpus” for said sentence which more effectively addresses and corrects the specific problems in said sentence in such a way that said SMT system can more effectively learn specifically “what it does not know”.
Said professional human translator will then utilize said Translation Error Correction system record information with which said professional human translator will correctly translate said source language sentence into a correctly translated corresponding target language sentence, thereby creating correctly translated “Parallel Corpus” source and target language sentences. Said correctly translated “Parallel Corpus” source and target language sentences will then be re-input to the SMT system, so that the SMT's inherent “learning process” will ensure that the same translation error will not occur again.
When all records (i.e. sentences) in a specific “Interactive Conversational Data Error Correction” conversation ( have been corrected as detailed above, the corrected “Bulk Material” document will then re-input for translation, and all previous translation errors should then be re-translated correctly. In the case that one or more errors still occur after said re-translation process, the above detailed use of said “Interactive Conversational Data Error Correction” system is repeated, and re-input for SMT translation until no further translation errors occur.

4.20-The “Sentence Information File” record corresponding to said specific sentence presented to said professional human translator is automatically retrieved (utilizing the unique Sentence Information File retrieval key stored in said “Translation Error Record”). In the case that said record indicates that a Voice Recognition (VR) error occurred during the transcription by VR module of said sentence from Voice to Text, said Source Sentence presented to said professional human translator will most probably be defective, and, the Audio recording of said single sentence as spoken by conversation participant is retrieved from said “Sentence Information File” and made available to said professional human translator. Said professional human translator may then listen to said auto recording of said Source Sentence, and manually transcribe the correct source sentence as spoken by said conversation participant. Said professional human translator may then proceed to correctly translated said “Parallel Corpus” source and target language sentences as detailed above.

### References Cited

1. Web Site: LanguageWeaver.com
2. Web Site: IBM's TJ Watson Research Laboratories
3. Wikipedia.org: “Statistical Machine Translation”
4. W. Weaver (1955). Translation (1949). In: Machine Translation of Languages, MIT Press, Cambridge, Mass.
5. P. Brown, S. Della Pietra, V. Della Pietra, and R. Mercer (1991). The mathematics of statistical machine translation: parameter estimation. Computational Linguistics, 19(2), 263-311.
6. P. Koehn, F. J. Och, and D. Marcu (2003). Statistical phrase based translation. In Proceedings of the Joint Conference on Human Language Technologies and the Annual Meeting of the North American Chapter of the Association of Computational Linguistics (HLT/NAACL).
7. D. Chiang (2005). A Hierarchical Phrase-Based Model for Statistical Machine Translation. In Proceedings of the 43rd Annual Meeting of the Association for Computational Linguistics (ACL'05).

### US Patent Documents Referenced

U.S. patent application Ser. No. 12/290,761 entitled “Voice Auto-Translation of Multi-Lingual Telephone Calls” filed on Nov. 3, 2008.

What is claimed is:

1. A Method that utilizes the inherent statistical nature of SMT in the translation of a source language sentence to a target language sentence, the individual “sentence” being the basic unit of SMT translation, to determine if said sentence has been translated correctly to the target language or not, comprising:
When said sentence contains phrase(s), and/or individual word(s) that have more than one possible meaning, said SMT translation process determines the statistical probability of each possible meaning of each said phrase or word utilizing statistical analytics derived from either or both the SMT language pair database and/or a particular domain database to determine the statistical “probability spread” of each possible meaning of each said phrase or individual word in said sentence being translated.
When said statistical “probability spread” relating to the possible different meanings of a particular phrase or word, in said sentence, that has more than one possible meaning is “statistically conclusive”, in that there is a high statistically valid probability in said statistical “probability spread”, relative to the “probability scores” of the other possible meanings of said phrase or word, points to one of said possible meanings of said word or phrase points as the “statistically conclusive”, said “statistically conclusive” meaning of said word or phrase is then chosen as the “correct meaning” of said word or phrase to be used in said translation of said sentence.
When said statistical “probability spread” relating to the possible different possible meanings of a particular phrase or word within said sentence is “statistically inconclusive”, in that there is not a high statistically valid probability in said statistical “probability spread”, relative to the “probability scores” of the other possible meanings of said phrase or word, that points to any one of the possible meanings of said word or phrase as the statistically correct meaning, said SMT system does not know and cannot determine which of the multiple possible meanings of said word or phrase is the “correct meaning” of said phrase or word. For example, in the case that the statistical “probability spread” of a phrase or word, within said sentence, that has four different possible meanings which are: 73%, 21%, 5% and 1% respectively, there is a high “statistically conclusive” probability that the meaning of the word or phrase correlating to the 73% probability of correctness, is indeed the correct meaning of said phrase or word. Alternately, in the case that the above said “probability spread” is 27%, 26% 25% and 22% respectively, there is no “statistically conclusive” probability that any of the meanings of said phrase or word correlating to the above “probability spread” is the “statistically correct” meaning, and the SMT system is unable to conclusively translate the above said phrase or word.
According to the present method, a sentence is determined to have been translated correctly, only in the event that every phrase and/or word within said sentence with more than one meaning, have respective “probability spreads” for said phrases and/or words within said sentence indicating that all of the chosen meanings for all phrases and/or words within said sentence, that have more than one possible meaning, are “statistically conclusive” choices, in which case said sentence is determined to have been “translated correctly”, otherwise said sentence is determined to have been “translated incorrectly”.

2. A method according to claim 1, in which said SMT system will be modified to determine if a translated sentence has either been “translated correctly” or “translated incorrectly”, as detailed in claim 1, and said SMT system will utilize an API (Application Program Interface) to extract and provide any external module with the below detailed information and/or any other method of extracting below detailed information from said SMT system for use by any external module, known to those skilled in the art:
1-Text of original Source Language Sentence
2-Text of translated Target Language Sentence
3-For sentences that contain phrase(s) and/or words with multiple meaning(s), a list of said phrase(s) and/or word(s) that the SMT system has determined to be “Statistically Inconclusive”.
4-An indicator whether said Source Language Sentence has either been “translated incorrectly” or “translated correctly”.
5-A unique file record identification key to be used for the creation and subsequent retrieval of an associated “Sentence Information File Record”. Note: Used only for “Auto-Translate VR Data, else=null.
6-Document (or) Auto-Translate Conversation Id
7-Source System Indicator—Bulk Text Material (or) Auto-Translate VR

3. A computer program according to claim 2, that will access and process said information extracted from said modified SMT system file, said program comprising
The creation of a “Translation Error File” file containing a unique file identification key, that uniquely identifies the specific “Bulk Text Material” document, submitted for SMT translation.
The generation of a “Translation Error File” record for each sentence translated sentence within said Bulk Text Material document. Said “Translation Error File” record will contain the below detailed data extracted from said SMT system subsequent to the translation by said modified SMT system of said sentence in said “Bulk Text Material” comprising:
1-Text of original Source Language Sentence
2-Text of translated Target Language Sentence
3-For sentences that contain phrase(s) and/or words with multiple meaning(s), a list of said phrase(s) and/or word(s) that the SMT system has determined to be “Statistically Inconclusive”.
4-An indicator whether said Source Language Sentence has either been “translated incorrectly” or “translated correctly”.
5-A unique file record identification key to be used for the creation and subsequent retrieval of an associated “Sentence Information File Record”. Note: Used only for “Auto-Translate VR Data, else=null.
6-Document (or) Auto-Translate Conversation Id
7-Source System Indicator—Bulk Text Material (or) Auto-Translate VR

4. A computer program according to claim 3, that utilizes said “Translation Error File” to create a “Bulk Material Translation Text Report” displaying the entire source language text of said bulk material on a computer screen or hardcopy paper report, with said individual sentences that have been determined by the SMT system to have a high probability of having been translated incorrectly either highlighted, or otherwise marked in any manner whatsoever so that user attention will be drawn to said incorrectly translated individual sentences, said report being generated for viewing on either hardcopy paper or computer screen, or by any other means known to those skilled in the art. Furthermore, said highlighting of said sentences that have been “translated incorrectly” will be highlighted in one color (e.g., yellow), while the specific phrase(s) and/or word(s) within said sentence that have multiple possible meanings which said SMT system has determined to be “Statistically Inconclusive” (i.e., was unable to choose the correct meaning for said phrase and/or word) will be highlighted in a different color (e.g., red). In this manner, said professional human translator(s) will know specifically which phrases and/or words said SMT system did not understand, and will be able to more effectively translate a “parallel Corpus” for said sentence which more effectively addresses and corrects the specific problems in said sentence in such a way that said SMT system can more effectively learn specifically “what it does not know”.

5. A “Bulk Material Translation Error Correction” system, according to claim 2, will be developed, said “Bulk Material Translation Error Correction” system comprising:
The selection of each said individual record in said “Translation Error File”” that contains a sentence that has been “translated incorrectly” by said modified SMT system will be presented to a professional human translator, one record (sentence) at a time by said Bulk Material Translation Error Correction” system.
The highlighting of said sentence that have been “translated incorrectly” and presented to a professional human translator, one record (sentence) at a time will be highlighted in one color (e.g., yellow), while the specific phrase(s) and/or word(s) within said sentence that have multiple possible meanings which said SMT system has determined to be “Statistically Inconclusive” (i.e., was unable to choose the correct meaning for said phrase and/or word) will be highlighted in a different color (e.g., red). In this manner, said professional human translator(s) will know specifically which phrases and/or words said SMT system did not understand, and will be able to more effectively translate a “parallel Corpus” for said sentence which more effectively addresses and corrects the specific problems in said sentence in such a way that said SMT system can more effectively learn specifically “what it does not know”.
Said selected “Translation Error File” record information, relating only to records containing sentences that have been “translated incorrectly”, are presented to said professional human translator by said Bulk Material Translation Error Correction” system will include both the source language sentence that was submitted for translation, as well as the corresponding target language sentence which was determined to have a high probability of having been “incorrectly translated” by the SMT system.
Said professional human translation will then utilize said Bulk Material Translation Error Correction system record information to correctly translate said source language sentence into a correctly translated corresponding target language sentence, thereby creating correctly translated “Parallel Corpus” source and target language sentences. Said correctly translated “Parallel Corpus” source and target language sentences will then be re-input to the SMT system, so that the SMT's inherent “learning process” will ensure that the same translation error will not occur again.
When all records (i.e. sentences) in a specific “Bulk Text Material” document have been corrected as detailed above, the corrected “Bulk Material” document will then re-input for translation, and all previous translation errors should then be re-translated correctly. In the case that one or more errors still occur after said re-translation process, the above detailed use of said Bulk Material Translation Error Correction system computerized sentence correction component is repeated, and re-input for SMT translation until no further translation errors occur.

6. A method according to claim 1, in which said SMT system will be modified in accordance to the requirements of “Interactive Conversational Data”, such as the “Voice Auto-Translation of Multi-Lingual Telephone Calls” as disclosed in U.S. patent application Ser. No. 12/290,761, in which said SMT module determines if a translated sentence has either been “translated correctly” or “translated incorrectly”, as detailed in claim 1, and said SMT system will utilize an API (Application Program Interface) and/or any other method of extracting below detailed information known to those skilled in the art, in order to extract and provide any external module with the below detailed information:
1-Text of original Source Language Sentence
2-Text of translated Target Language Sentence
3-For sentences that contain phrase(s) and/or words with multiple meaning(s), a list of said phrase(s) and/or word(s) that the SMT system has determined to be “Statistically Inconclusive”.
4-An indicator whether said Source Language Sentence has either been “translated incorrectly” or “translated correctly”.
5-A unique file record identification key to be used for the creation and subsequent retrieval of an associated “Sentence Information File Record”. Note: Used only for “Auto-Translate VR Data, else=null.
6-Document (or) Auto-Translate Conversation Id
7-Source System Indicator—Bulk Text Material (or) Auto-Translate VR

7. A computer program according to claim 6, that will access and process said information extracted from said modified SMT system, said program comprising
The creation of a “Translation Error File” containing a file identification key, that uniquely identifies the specific conversation, and the associated conversation Source Language text submitted for SMT translation.
The generation of a record in said “Translation Error File” record for each “incorrectly translated” sentence within said “Interactive Conversational Data” that has been determined to have been “translated incorrectly by said SMT system. Said “Translation Error File” will contain the below detailed data extracted from said SMT system subsequent to the translation of said sentence by said SMT system.
1-Text of original Source Language Sentence
2-Text of translated Target Language Sentence
3-For sentences that contain phrase(s) and/or words with multiple meaning(s), a list of said phrase(s) and/or word(s) that the SMT system has determined to be “Statistically Inconclusive”.
4-An indicator whether said Source Language Sentence has either been “translated incorrectly” or “translated correctly”.
5-A unique file record identification key to be used for the creation and subsequent retrieval of an associated “Sentence Information File Record”. Note: Used only for “Auto-Translate VR Data, else=null.
6-Document (or) Auto-Translate Conversation Id
7-Source System Indicator—Bulk Text Material (or) Auto-Translate VR
The creation of a “Sentence Information File” for “Interactive Conversational Data” that uniquely identifies the specific “Interactive Conversational Data” conversation submitted for SMT translation. The storage and retrieval key for said record is derived from said “unique file record identification key” which is located in the above associated “Translation Error File” record. A single “Sentence Information File” record is generated for each sentence, which said SMT module has determined to be “translated incorrectly”.
Said “Sentence Information File” record will contain the below detailed data extracted from said SMT system subsequent to the translation of an “incorrectly translated” sentence, as follows:
1-Audio recording of said single sentence as spoken by conversation participant.
2-Identification of conversation participant who spoke said single sentence.
5-Unique ID for said specific telephone conversation processed by the “Voice Auto-Translation of Multi-Lingual Telephone Calls” system.
6-Indicator of if a Voice Recognition (VR) error occurred during the transcription by VR module of said sentence from Voice to Text.

8. A “Interactive Conversational Data Error Correction” system, according to claim 6, will be developed, said “Interactive Conversational Data Error Correction” system comprising:
The selection of each said individual record in said “Translation Error File” that contains a sentence that has been “translated incorrectly” by said modified SMT system will be presented to a professional human translator, one record (sentence) at a time by said “Interactive Conversational Data Error Correction” system.
Said selected “Translation Error File” record information, relating only to records containing sentences that have been “translated incorrectly”, are presented to said professional human translator by said “Interactive Conversational Data Error Correction” system will include both the source language sentence that was submitted for translation, as well as the corresponding target language sentence which was determined to have a high probability of having been “incorrectly translated” by the SMT system.
The highlighting of said sentence that have been “translated incorrectly” and presented to said professional human translator, one record (sentence) at a time will be highlighted in one color (e.g., yellow), while the specific phrase(s) and/or word(s) within said sentence that have multiple possible meanings which said SMT system has determined to be “Statistically Inconclusive” (i.e., was unable to choose the correct meaning for said phrase and/or word) will be highlighted in a different color (e.g., red). In this manner, said professional human translator(s) will know specifically which phrases and/or words said SMT system did not understand, and will be able to more effectively translate a “parallel Corpus” for said sentence which more effectively addresses and corrects the specific problems in said sentence in such a way that said SMT system can more effectively learn specifically “what it does not know”.
Said professional human translator will then utilize said Translation Error Correction system record information with which said professional human translator will correctly translate said source language sentence into a correctly translated corresponding target language sentence, thereby creating correctly translated “Parallel Corpus” source and target language sentences. Said correctly translated “Parallel Corpus” source and target language sentences will then be re-input to the SMT system, so that the SMT's inherent “learning process” will ensure that the same translation error will not occur again.
When all records (i.e. sentences) in a specific “Interactive Conversational Data Error Correction” conversation ( have been corrected as detailed above, the corrected “Bulk Material” document will then re-input for translation, and all previous translation errors should then be re-translated correctly. In the case that one or more errors still occur after said re-translation process, the above detailed use of said “Interactive Conversational Data Error Correction” system is repeated, and re-input for SMT translation until no further translation errors occur.

9. A method according to claim 7, wherein the “Sentence Information File” record corresponding to said specific sentence presented to said professional human translator is automatically retrieved (utilizing the unique Sentence Information File retrieval key stored in said “Translation Error Record”). In the case that said record indicates that a Voice Recognition (VR) error occurred during the transcription by VR module of said sentence from Voice to Text, said Source Sentence presented to said professional human translator will most probably be defective, and, the Audio recording of said single sentence as spoken by conversation participant is retrieved from said “Sentence Information File” and made available to said professional human translator. Said professional human translator may then listen to said auto recording of said Source Sentence, and manually transcribe the correct source sentence as spoken by said conversation participant. Said professional human translator may then proceed to correctly translated said “Parallel Corpus” source and target language sentences as detailed in claim #8 (above).
